(19) United States
(12) Patent Application Publication
(10) Pub. No.: US 2009/0174618 A1
(43) Pub. Date: Jul. 9, 2009

(54) RF module integrated with active antenna

(76) Inventors: Chung-Er Huang, Xindian (TW); Chih-Hao Liao, Xindian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,270

(22) Filed: Jan. 9, 2008

(51) Int. Cl. H01Q 1/40; H01P 11/00; H01Q 7/00

(52) U.S. Cl. 343/748; 343/873; 29/600

(57) ABSTRACT

A radio frequency (RF) module integrated with an active antenna includes a silicon chip carrier, an active antenna circuit and a main circuit unit. The active antenna circuit unit is integrated into the silicon chip carrier via a semiconductor process. The active antenna circuit unit further includes an antenna loop formed on the silicon chip carrier for receiving and transmitting an RF signal. The active circuit unit is mounted on the silicon chip carrier and electrically connected to the active antenna circuit unit for processing the RF signal. Thereby the module is made compact.

### BACKGROUND OF THE INVENTION

1. Field of the Invention

The invention generally relates to a radio frequency (RF) module integrated with an active antenna, and more particularly to an RF module in which the active antenna is integrated into the carrier, and to a method of manufacturing the RF module.

2. Description of the Related Art

With the rapid development of wireless radio frequency transmission technology, the RF antenna has been widely used. In theory, the length of single-pole antenna is at least one forth of the transmitted wavelength so as to provide good receiving and transmitting efficiency. For an RF module using a frequency of 2.4 GHz, the length of the single-pole antenna is around 3.125 cm.

However, this length is by far out of the range required to make the module compact. An attempt has been made to solve this problem by connecting short single-pole antennas in series to form an active antenna module by means of an antenna control module. Using the gain property of the antenna control module, which can make the electrical length equivalent, the receiving and transmitting efficiencies of the antenna are controlled by adjusting the variable conductance, thereby improving the problem of narrow frequency width for the single-pole antenna.

For the current technology, most of the commercial available RF modules integrated with an antenna use printed circuit boards (PCB), epoxy resin (FR-4) substrates or Bismaleimide Triazine (BT) substrates as their main carriers. Antenna patterns are made on the carrier, and then all chips, devices and the antennas of the control module are mounted on the carrier by Surface Mount Technology (SMT). The carrier is just used to support the chips and devices. Electrical connection among the chips, devices and the antenna patterns are made in layers in the carrier.

As such, not only the cost increases as the numbers of the chips and the devices increase, but also the carrier needs to become larger to accommodate all circuits and the routing of the circuits.

Therefore, there is a need for a carrier for the RF module which satisfies the requirements of multi-functions, small volume and low production cost.

### SUMMARY OF THE INVENTION

It is an object of the invention to provide an RF module which integrates the active antenna circuit into the carrier to significantly reduce the size of the whole module. The active antenna circuit is very close to the main circuit so that the electrical properties of the RF module can be enhanced.

In order to achieve the above and other objectives, the radio frequency (RF) module integrated with an active antenna according to the invention includes a silicon chip carrier, an active antenna circuit and a main circuit unit. The active antenna circuit unit is integrated into the silicon chip carrier via a semiconductor process. The active antenna circuit unit further includes an antenna loop formed on a surface of the silicon chip carrier for receiving and transmitting an RF signal.

The active circuit unit is mounted on the surface of the silicon chip carrier and electrically connected to the active antenna circuit unit for processing the RF signal.

Furthermore, the invention also provides a method of manufacturing an RF module integrated with an active antenna. The method includes providing an active antenna circuit unit having an antenna loop; forming a silicon chip carrier where the active antenna circuit unit is integrated with by a semiconductor process, wherein the antenna loop of the active antenna circuit unit is integrated onto the surface of the silicon chip carrier; and mounting a main circuit unit onto the surface of the silicon chip carrier to electrically connect to the active antenna circuit unit. Thereby, the whole module can be made compact and widely applied to various products.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a schematic view of an RF module integrated with an active antenna according to one embodiment of the invention;

FIG. 2 is a graph of an amplifier circuit gain versus frequency response according to one embodiment of the invention; and

FIG. 3 is a flow chart of a method of manufacturing an RF module integrated with the active antenna according to one embodiment of the invention.

### DETAILED DESCRIPTION OF THE EMBODIMENTS

Wherever possible in the following description, similar reference numerals will refer to corresponding elements and parts in different drawings unless otherwise illustrated.

The invention provides a carrier, with a configuration different from the prior art, which receives all devices of a (radio frequency) RF module and related circuits of active antennas, thereby reducing the volume of the RF module. With the use of the carried of the invention, the RF module can be applied to all products which need RF transmission.

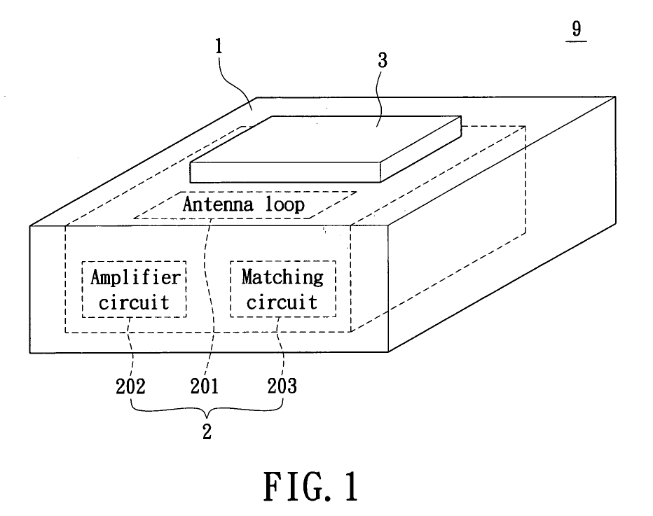

FIG. 1 is a schematic view of an RF module integrated with an active antenna according to one embodiment of the invention. As shown, an RF module 9 integrated with an active antenna includes a silicon chip carrier 1, an active antenna circuit unit 2 and a main circuit unit 3. The silicon chip carrier 1 supports devices of the RF module 9.

The main antenna circuit unit 2 is directly integrated with the silicon chip carrier 1 by a semiconductor process during the formation of the silicon chip carrier 1. The active antenna circuit unit 2 further includes an antenna 201, an amplifier circuit 202 and a matching circuit 203. The antenna loop 201 is formed on the surface of the silicon chip carrier 1 to receive an RF signal. The amplifier circuit 202 is formed in the silicon chip carrier 1 and electrically connected to the antenna loop 201 in order to magnify the RF signals. The matching circuit 203 is also formed in the silicon chip carrier, and electrically connected to the amplifier circuit 202 in order to tune the response frequency of the amplifier circuit 202 in response to the RF signal. The matching circuit 203 is, but not limited to, one of a variable conductance circuit, a variable capacitance circuit and the combination thereof.

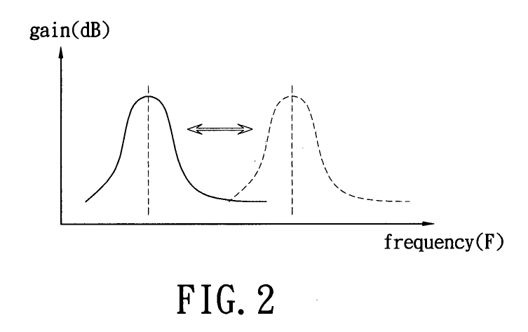

FIG. 2, which is a graph of an amplifier circuit gain versus frequency response, illustrates results of frequency tuning of the matching circuit 203. The horizontal axis represents the response frequency (F) and the vertical axis represents gains (dB). The response frequency (F) can be tuned by changing outputs such as conductance values of the matching circuit 203 so as to change the receiving and transmitting frequencies of the antenna loop 201.

The main circuit unit 3 is mounted on the silicon chip carrier 1 by Surface Mount Technology (SMT), for example, and electrically connected to the active antenna circuit unit 2 to process the RF signals. It is known that the main circuit unit 3 is not limited to a single circuit, but instead includes various controllers or circuits such as receivers, transmitters or power detecting circuits. The operations of these controllers or circuits are not related to the invention and therefore omitted here.

The location of the silicon chip carrier 1 where the main circuit unit 3 is mounted and the location of the silicon chip carrier 1 where the antenna loop 201 is mounted can be on the same surface at different levels or at different distances from each other. In terms of better signal quality, short routing for circuits is preferred.

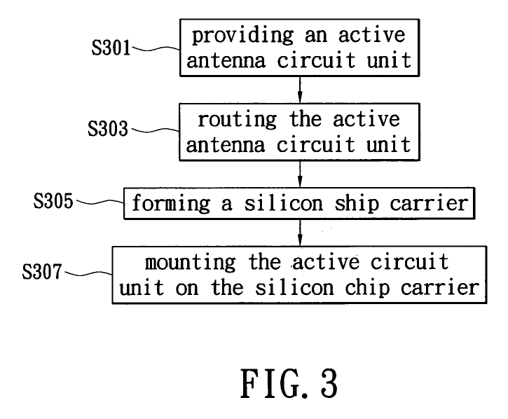

FIG. 3 is a flow chart of manufacture of an RF module integrated with the active antenna according to one embodiment of the invention. As shown, the method of manufacturing an RF module 9 integrated with an active antenna includes providing an active antenna circuit unit 2 (S301); routing the active antenna circuit unit 2 according to requirements to signal quality to generate a circuit layout (S303).

The circuit layout is integrated with the active antenna circuit unit 2 via a semiconductor process to form the silicon chip carrier 1 (S305). The semiconductor process can include, for example, a series of steps carried out from the beginning of manufacturing a silicon wafer, including photolithography, rapid high temperature process, chemical vapor phase deposition, ion implantation and etching to form, layer by layer, the silicon chip carrier 1 with functional circuits. The antenna loop 201 in the active antenna circuit unit 2 is formed on the silicon chip carrier 1 by etching.

Finally, the silicon chip carrier 1 where the main circuit unit 3 is mounted is electrically connected to the active antenna circuit unit 2 integrated with the silicon chip carrier 1 (S307). Therefore, the RF module 9 having a compact active antenna circuit 2 is achieved.

In light of the foregoing, the integration of the active antenna circuit into the carrier significantly reduces the volume of the RF module. In addition, the invention further provides the following advantages.
1. The electric properties of the RF module are improved. The active antenna circuit unit is pretty close to the main circuit unit so that signal decay occurred because of long transmission distance can be avoided, while enhancing the electrical properties of the RF module.
2. Noise interference is prevented. The integration of the active antenna circuit unit into the silicon chip carrier allows the routing between the antenna and the main circuit unit be protected from any noise interference.
3. The temperature of the module is reduced. The silicon chip module with good thermal conductivity contributes to lower the temperature of the RF module.
4. The manufacture cost is reduced. The whole active antenna circuit unit is integrated into the silicon chip carrier. Therefore, the carrier of the invention, which has larger surface area than conventional carriers, can be made using low-end processing such as a 0.5 micrometer process. In this way, the manufacture cost is reduced compared to the prior art that requires high-end processing for manufacture.
5. The antenna frequency is improved. The active antenna circuit is used to control the receiving and transmitting frequencies of the antenna by adjusting the size of the matching circuit, such as adjusting the conductance in the variable conductance circuit. In this way, multiple frequency band operation can be achieved, which makes the antenna frequency width broader than that of a passive antenna.
   It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A radio frequency (RF) module integrated with an active antenna, the module comprising:
a silicon chip carrier;
an active antenna circuit unit, integrated into the silicon chip carrier, the active antenna circuit further comprising an antenna loop, formed on a surface of the silicon chip carrier to receive and transmit an RF signal; and
an active circuit unit, mounted on the surface of the silicon chip carrier and electrically connected to the active antenna circuit unit to process the RF signal.

2. The RF module integrated with an active antenna of claim 1, wherein the antenna loop is formed on the surface of the silicon chip carrier by etching.

3. The RF module integrated with an active antenna of claim 1, wherein the active antenna circuit unit further comprises:
an amplifier circuit, connected to the antenna loop;
a matching circuit, connected to the amplifier circuit to tune the response frequency needed for tuning the amplifier circuit.

4. The RF module integrated with an active antenna of claim 3, wherein the matching circuit is one of a variable conductance circuit, a variable capacitance circuit or the combination thereof.

5. The RF module integrated with an active antenna of claim 1, wherein the connection between the main circuit unit and the active antenna circuit unit is made by Redistribution Layer technology.

6. A method of manufacturing a radio frequency (RF) module integrated with an active antenna, comprising:
providing an active antenna circuit unit having an antenna loop;
forming a silicon chip carrier where the active antenna circuit unit is integrated with by a semiconductor process; and
mounting a main circuit unit onto the silicon chip carrier to electrically connect the active antenna circuit unit;
wherein the antenna loop of the active antenna circuit unit is integrated onto the silicon chip carrier.

7. The method of manufacturing a radio frequency (RF) module integrated with an active antenna of claim 6, further comprising routing the active antenna circuit unit to generate a circuit layout for the integration of the active antenna circuit unit with the silicon chip carrier.

8. The method of manufacturing a radio frequency (RF) module integrated with an active antenna of claim 6, wherein the antenna loop is formed on the silicon chip carrier by etching.

9. The method of manufacturing a radio frequency (RF) module integrated with an active antenna of claim 6, wherein the connection between the main circuit unit and the active antenna circuit unit is made by Redistribution Layer technology.
